(19) United States
(12) Patent Application Publication
(10) Pub. No.: US 2008/0118136 A1
(43) Pub. Date: May 22, 2008

(54) Propagating Shell for Segmenting Objects with Fuzzy Boundaries, Automatic Volume Determination and Tumor Detection Using Computer Tomography

(75) Inventors: Wenli Cai, Dorchester, MA (US); Gordon J. Harris, Lexington, MA (US); Hiroyuki Yoshida, Watertown, MA (US)

Correspondence Address: BROMBERG & SUNSTEIN LLP, 125 SUMMER STREET, BOSTON, MA, 02110-1618, US

(73) Assignee: THE GENERAL HOSPITAL CORPORATION, Boston, MA (US)

(21) Appl. No.: 11/943,577

(22) Filed: Nov. 20, 2007

Related U.S. Application Data
(60) Provisional application No. 60/860,198, filed on Nov. 20, 2006.

(51) Int. Cl. G06K 9/00

(52) U.S. Cl. 382/131

(57) ABSTRACT

A dynamic thresholding level set method combines two optimization processes, i.e., a level set segmentation and an optimal threshold calculation in a local histogram, into one process that involves a structure called a “propagating shell.” The propagating shell is a mobile 3-dimensional shell structure with a thickness that encompasses the boundary of an object, the boundary between two objects or the boundary between an object and a background. Because the local optimal threshold tends to shift to a value of a small region in a histogram, the shift can drive the propagating shell to an object boundary by pushing or pulling the propagating shell. The segmentation process is an optimizing process to find a balanced histogram with minimal threshold shift. When the histogram in the propagating shell is balanced, the optimal threshold becomes stable, and the propagating shell reaches a convergence location, i.e., an object boundary. This method can be applied to computer-aided organ and tumor volumetrics.

### CROSS REFERENCE TO RELATED APPLICATIONS

This application claims the benefit of U.S. Provisional Patent Application No. 60/860,198, filed Nov. 20, 2006, titled “Automatic Volume Determination and Tumor Detection Using Computer Tomography,” the contents of which are hereby incorporated by reference.

### TECHNICAL FIELD

The present invention relates to computed tomography (CT) and, more particularly, to methods and systems for segmenting objects with fuzzy boundaries in CT image data.

### BACKGROUND ART

Computed tomography (CT) plays a major role in imaging livers and other organs. Hepatic CT images provide the major clinical indication for detection and characterization of hepatic lesions (Otto, et al, 2005). Measurement of the volume of focal liver tumors, called liver tumor volumetrics, is indispensable for assessing the growth of tumors and for monitoring the response of tumors to oncology treatment. In addition, precise organ volumetry is gaining significance in various clinical settings for patient selection for appropriate management, surgery planning and disease status monitoring (Yonemura, et al., 2005; Dempsey, et al., 2005). Traditionally, kidney size/diameter measurements, taken from images of the organ, have been used as surrogates to supplement these clinical needs. However, a kidney size measurement is an imperfect measure of the organ's overall volume. Three-dimensional kidney volumetry is preferred in living kidney donors (Herts, 2005), in assessing progression of polycystic renal disease (Sise, et al., 2000) and for tumor burden and treatment response evaluation (Kim, et al., 2004; Ozono, et al., 2004).

Linear tumor measurement, including both the bidimensional measurement approach described in World Health Organization (WHO) guidelines and the unidimensional measurement approach described in the Response Evaluation Criteria in Solid Tumors (RECIST) guidelines (Therasse, et al., 2000), is the current state of the art for measuring the size of tumors in clinical practice. Patient response to treatment is evaluated based on the measurement of the growth or shrinkage of the tumors. However, results of a study by Hopper, et al. (1996), showed considerable interobserver variation among radiologists in linear tumor measurements, especially for ill-defined and irregular lesions. Moreover, a study by Prasad, et al (2002), showed that volumetrics provided substantially different results (approximately 30%) from those obtained by unidimensional and bidimensional measurements in the evaluation of the treatment response of liver metastases. Furthermore, studies showed that volumetric measurements of focal tumors can provide more reliable and objective estimates of tumor responses that agree with clinical outcomes than are obtainable from linear measurements. (Dempsey, et al., 2005; Tran, et al., 2004; Van Hoe, et al., 1997).

Segmentation of tumors is an essential step for tumor volumetrics. However, manual measurement of tumor volumes requires contouring of the tumors in CT images, which is labor intensive and prone to errors. Thus, manual measurement is generally prohibitively time-consuming and costly in clinical practice. Efficient and accurate segmentation of tumors in hepatic CT images continues to be an active research area, because of the complexity of hepatic lesions.

Several automated and semi-automated liver tumor segmentation methods have been developed. Examples include the delineation of liver tumors by a pre-defined threshold in a user-defined region of interest, a watershed region partitioning approach, c-means clustering, and texture analysis. Most methods assume that the boundary of a tumor is relatively clear, that is, the contrast of the tumor, relative to the background, is high. However, in reality, many tumors have a fuzzy boundary that is characterized by a gradual transition from the tumor region to the background region. In these cases, the edge of a segmented tumor may differ substantially from the true boundary of the tumor.

As noted, segmentation of the kidney from CT images is an essential step for renal volumetry. However, manual segmentation of a kidney requires contouring of the kidney boundary on each renal CT image, which is labor-intensive and prone to inter-operator variability. Computerized volumetry, on the other hand, relies on an efficient and accurate segmentation method, which is a subject of active research in medical image processing. To reduce the labor of manual contouring, it is common to use a 2-dimensional deformable model, i.e., a closed deformable curve, often called a snake, to assist in user contouring. This model requires initialization of the curve on each axial image.

Existing kidney segmentation methods can be classified into three categories: thresholding and adaptive region-growing methods, deformable models, and knowledge-based methods. A successful segmentation relies on two factors: (1) a precise edge model to define the boundary of object, and (2) an efficient segmentation algorithm to detach object from its background.

Most computerized methods are guided by a zero-crossing edge model, in which the edge is defined by the maximum point of gradient or the zero point of second-derivatives (Gonzalez and Woods 1992). This model is derived in the context of optical images of the natural world: the discontinuity of image luminance is taken to be an edge. However, due to the inherent features and partial volume effects in medial images, this gradient or zero-crossing model is not appropriate for most tomographic images, such as CT and magnetic resonance imaging (MRI). For such images, blur present at the object periphery is not caused by distortion or noises. The blur most likely depicts an edge property, such as a gradual decrease in tissue thickness, in tissue density or in the concentration of contrast agent. Direct application of a zero-crossing edge model to a fuzzy boundary will not usually indicate the same location that a human observer would choose (Mather and Morgan 1986).

On the other hand, a human perception model tends to localize the object periphery where the object starts to “pull above” the background in an image. For example, when contouring tumors, all the visible tumor tissues are typically labeled as lesions, rather than at the midpoint of the edge response, which is taken usually by the zero-crossing edge model. Research by Morgen, et al. (1984), Mather and Morgan (1986), and Georgeson and Freeman (1997) clearly shows that there is a shift in perceived edge location away from the zero-crossing. This shift tends to move the zero-crossing of the second-derivative towards darker parts of the edge, due to a so-called “irradiation effect” (Mather and Morgan 1986). The magnitude of the shift increases with an increase in magnitude of both the edge blur and contrast. Experiments by Claridge (1998) demonstrated that the zero-crossing boundary of lesions tends to be shrunk by an average of three to four pixels from the boundary of the human perception model. Thus, an edge estimation model that coincides with the object periphery of the human perception model may improve the accuracy of segmentation in medical images.

Thresholding is the most direct method to distinguish an object from its background (Sezgin and Sankur, 2002). Optimal thresholding methods rely on the maximization (or minimization) of a merit function in a histogram, such as minimizing a within-class variance (Otsu, 1979), maximizing between-class variance (Ridler and Calvard, 1978), maximum of entropy (Kapur et al, 1985), minimum-error fitting (Kittler and Illingworth, 1986; Glasbey, 1993), etc. Ideally, the threshold between two materials is determined by their probability density functions (PDFs). A histogram is a weighted sum of PDFs by occupied regions of each material in an image, i.e. the percentage of the material in the image. The merit function calculating the optimal threshold is weighted by the probability in the histogram, such as a weighted sum of group mean, weighted sum of group variance, etc. If an object has a small region in an image, the object has fewer weights in the optimization merit. Thus, the optimal threshold from a global histogram tends to be different from the theoretic threshold from the PDF.

To overcome the inaccuracy of a thresholding value in a global histogram, Ibrahim and Aggoun (1992) suggested analyzing local windows in which the histogram would appear bimodal if a significant edge exists. Standard techniques can then be used to threshold the edge in the window, such as local contrast (Bernsen, 1986) or local variance (Sauvola and Pietaksinen, 2000). Both researchers used 15×15 windows. Kamel and Zhao (1993) used a center-surround scheme. Since the application background of these methods are document images, a 15×15 window might big enough to reach the edge of a letter or other character. However, in medical applications, the dilemma is that both the size of a region of interest (ROI) and the percentage of each material are unknown before segmentation is done. The difference between an optimal threshold and a theoretic threshold is minimized when the percentages of two materials in a local histogram are the same. The challenge is determining where to locate the window and how to sample the local histogram to be a combination of two PDFs with equal weights.

Segmenting structures from medical images is difficult due to the complexity and variability of the anatomic structures. Tradition segmentation algorithms, such as region growing, edge tracking and morphological operations, rely on clear boundaries or a well-defined edge model. But sampling noises and artifacts in medical images may cause leakage due to indistinct or disconnected boundaries. As a result, traditional methods require considerable amounts of expert intervention and/or a priori knowledge of structures (McInerney and Terzopoulos, 1996a). Furthermore, automating these approaches is difficult, because of the shape complexity and variability within and scross individual structures.

Deformable models (curve or surface), on the other hand, provide a geometric representation of the shape of objects and the constraints on boundaries, such as snakes (Kass et al., 1988), Fourier parameterized model (Worring, et al., 1996), physics-based model (Metaxas, 1996) and 3D deformable model (McInerney and Terzopoulos, 1996b). They combine desirable features, such as connectivity and smoothness, to counteract noise and boundary irregularities. Level set methods (Osher and Sethian, 1988), or implicit geometric deformable models, provide an elegant solution to address the re-parameterization limitation of parametric deformable models when a topology of an object changes, such as when the object merges or splits. The boundary of an object is implicitly represented as the zero-level set of a level set function (Sethian, 1996).

Level set methods or other deformable methods rely on a surface-fitting strategy. There is a variety of surface-fitting functions that can be used in succession or simultaneously, in a linear combination, to form a speed function F(x) (Whitaker, et al., 2001). The speed function is ideally 0 (zero) on the boundary and 1 (one) within an object. Most common image speed functions are related to edge detectors, such as gradient or second-derivative operators, which are combined with curvature speed function and other smoothness constraints to smooth out an otherwise rough surface solution. Despite the fact that zero-crossing edge models tend to segment “smaller” objects than the human perception model, the propagating force (calculated by gradient or other second-derivative speed function) on an interface at locations of missing or fuzzy boundaries is often strong enough to counteract the curvature constraints and leaks through these gaps (Sean, et al, 2002). Thus, level set methods need a proper edge model to segment objects with fuzzy boundaries in medical applications.

### SUMMARY OF THE INVENTION

A dynamic thresholding level set method combines two optimization processes, i.e., a level set segmentation and an optimal threshold calculation in a local histogram, into one process that involves a structure we call a “propagating shell.” The propagating shell is a mobile 3-dimensional shell structure with a thickness that encompasses the boundary of an object, the boundary between two objects or the boundary between an object and a background. Because the local optimal threshold tends to shift to a value of a small region in a histogram, the shift can drive the propagating shell to an object boundary by pushing or pulling the propagating shell. The segmentation process is an optimizing process to find a balanced histogram with minimal threshold shift. When the histogram in the propagating shell is balanced, the optimal threshold becomes stable, and the propagating shell reaches a convergence location, i.e., the object boundary. This method can be applied to computer-aided organ and tumor volumetrics.

An embodiment of the present invention provides a method for segmenting an object that is represented by image data. The method includes defining a region that encompasses a boundary between at least a portion of the object and at least part of a second object. The method also includes evolving the region by use of a dynamic-thresholding speed function. The second object may be a background. Defining the region may include initializing a level set front to at least a portion of the object. Evolving the region may include an iterative process. The dynamic-thresholding speed function may include an image-feature-based speed term. The dynamic-thresholding speed function may further include a curvature-based smoothness constraint term. The image-feature-based speed term may represent a difference between a computed tomography value at a point in the region and a threshold value calculated dynamically from a histogram of the region.

### BRIEF DESCRIPTION OF THE DRAWINGS

The invention will be more fully understood by referring to the following Detailed Description of Specific Embodiments in conjunction with the Drawings, of which:

FIG. 1 illustrates an interface that separates one region from another region in an image, according to the prior art;

FIG. 2 illustrates an expansion of the interface of FIG. 1, according to the prior art;

FIG. 3 illustrates a level set approach to interfaces, according to the prior art;

FIG. 4 illustrates a complex level set, according to the prior art;

FIG. 5 is a schematic diagram of a propagating shell, according to one embodiment of the present invention;

FIG. 6 illustrates a histogram of a background and a foreground and a dynamic speed function, according to one embodiment of the present invention;

FIG. 7 illustrates three stages of propagation of a shell, such as the shell of FIG. 5, according to one embodiment of the present invention;

FIG. 8 is a 3D image of segmented left and right kidneys;

FIG. 9 is a 2D axial slice of the resulting CT image of the kidneys of FIG. 8;

FIGS. 10 and 11 show the segmented left and right kidneys of FIGS. 8 and 9 in an ex-vivo CT scan, created using an embodiment of the present invention;

FIG. 12 shows the application of a three-stage volumetric scheme to a clinical case; according to one embodiment of the present invention;

FIG. 13 illustrates a probability density function of two materials and how an optimal threshold is calculated; according to one embodiment of the present invention;

FIG. 14 illustrates a histogram with two real roots;

FIG. 15 illustrates histograms of two materials with different foreground-to-background ratios;

FIG. 16 contains schematic diagrams of a propagating shell, an imaged object, the shell overlaying the imaged object and a corresponding histogram, according to an embodiment of the present invention; and

FIG. 17 is a schematic diagram that illustrates a discrete model, three-layer propagation shell and the relationship between medial axis movement and status updating, according to one embodiment of the present invention.

### DETAILED DESCRIPTION OF SPECIFIC EMBODIMENTS

In accordance with embodiments of the present invention, methods and apparatus are disclosed for 3-dimensional (3D) segmentation in image data representing objects with fuzzy boundaries. We observed that zero-crossing edge models and maximum gradient models can not supply accurate segmentation for such objects in medical images. By analyzing the histogram and the Gaussian mixture model, we observed that the optimal threshold shifts towards small regions in the images, compared to the theoretic threshold. Thus, when the volume ratio between object and background is about 1:1 in the histogram, the optimal threshold approximates the theoretic threshold. We designed a shell structure (called a “propagating shell”), which is a thick region that encompasses an object boundary. The propagating shell is driven by the threshold shift between the optimal threshold and the theoretic threshold. When the volume ratio of object and background in the shell approaches 1:1, the optimal threshold is a best fit for the theoretic threshold, and the shell stops moving. This method combines an edge model into a level set implementation. The result provides an objective and accurate segmentation of objects with fuzzy boundaries.

Histogram analysis is one of the most popular methods for computing a threshold value that separates a solid object from the background (Gonzalez, et al, 2002). Generally, such a threshold value is set at a valley (or a local minimum) of the histogram of an image, if, in the histogram, the peaks that correspond to the tumor region and to the background region are tall, narrow, symmetric, and separated by a deep valley. In practice, however, the shape of the histogram is affected by various factors such as the sizes of the tumors, the variance of the pixel values in each tumor and the number of tumors in the image. Therefore, the valley of the histogram does not always correspond to the threshold value that provides the most plausible tumor region. This phenomenon is referred to as “threshold shifting,” that is, the valley of the histogram tends to be shifted to a value that generates a tumor size smaller than the tumor actually is (Gonzalez, et al, 2002).

In a two-dimensional example, if boundary analysis is limited to a region that includes only two features, A (an object) and B (the background), and the size ratio of these two features, referred to as the background-to-foreground (BtF) ratio, is approximately 1:1, the threshold shift, ΔTh, will be minimized at a position Xₘᵢₙ by:

xₘᵢₙ=(M_{A}+M_{B})/2+ΔTh, ΔTh=σ²·ƒ·1n(C_{R}) (1)

where M_{A} and M_{B} are expected intensity values of object A and background B, respectively; σ² is the variance of the white-noise distribution; ƒ=1/(M_{A}−M_{B}) is a scale factor of the two expected intensity values; C_{R}=R_{B}/R_{A} is the BtF ratio; and R_{A} and R_{B} are the number of voxels of object A and background B, respectively.

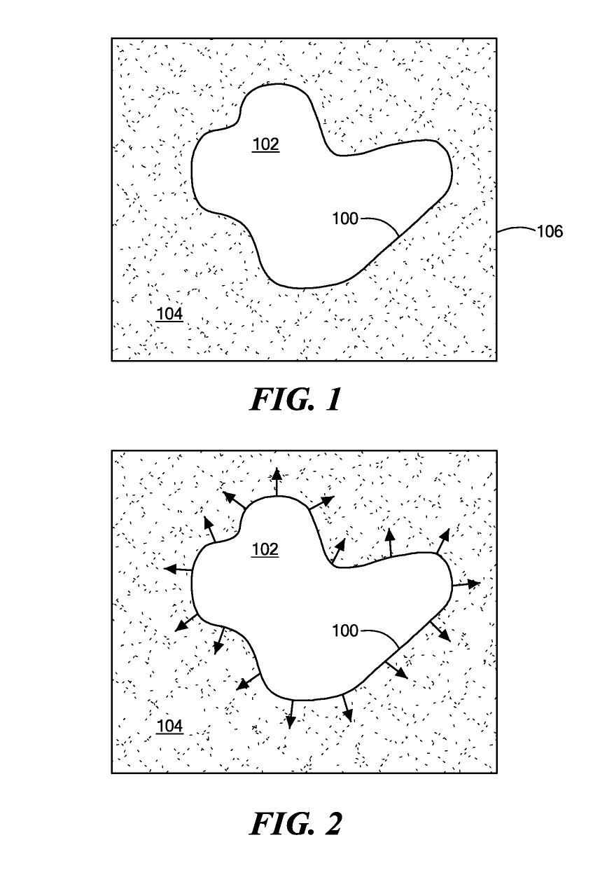

An interface separates one region from another region, such as an organ and a background. For example, as illustrated in FIG. 1, an interface 100 separates one region 102 from another region 104 in an image 106. A speed function describes how each point along the interface 100 is to be moved. For example, the interface 100 may be expanded or its shape may be changed to more accurately approximate the size and/or shape of an organ or a tumor. FIG. 2 illustrates expansion of the interface 100. Modeling the shape of the interface 100 can become difficult, particularly if the interface 100 crosses itself or if the region 102 is broken into two regions.

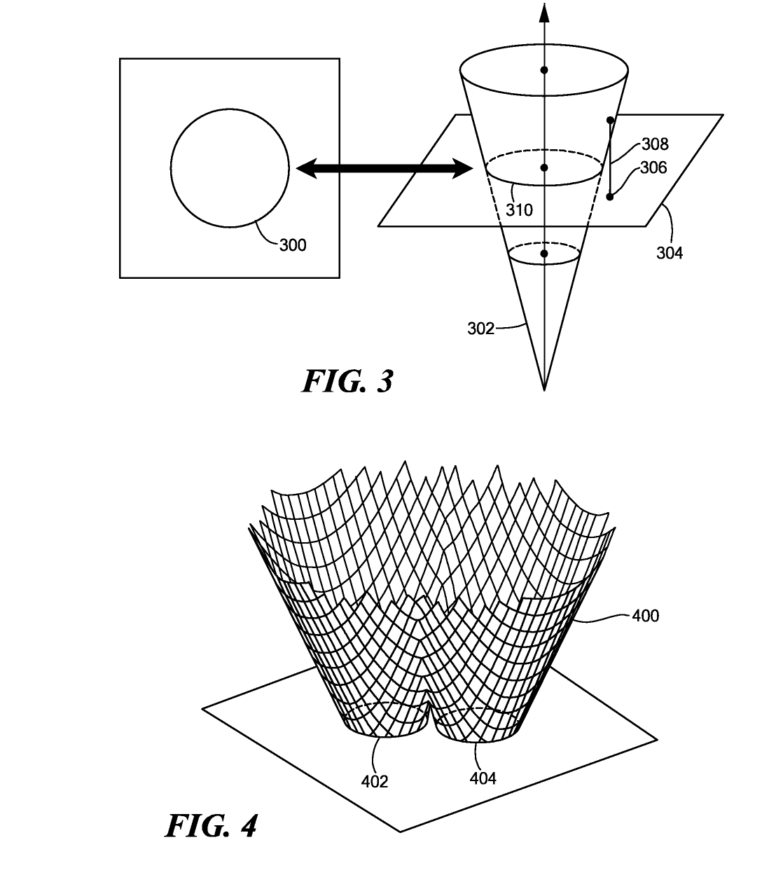

Rather than modeling the interface 100 itself, the level set approach introduced by Osher and Sethian builds a surface, a cross-section of which yields the interface 100. For example, as illustrated in FIG. 3, if an interface 300 is a circle, a cone 302 can be defined, such that the cone 302 intersects an x-y plane 304 at every point of the interface 100. The surface (here, the cone 302) is called a level set function, because it accepts as an input any point, such as point 306, in the x-y plane 304 and returns the height, such as height 308, of the point on the surface. The surface intersects the x-y plane 304 at height zero. Thus, the intersection 310 of the surface is called the zero level set. More complex intersections are represented by more complex surfaces. For example, as illustrated in FIG. 4, a complex surface 400 can be used to represent an interface that consists of two distinct portions 402 and 404.

### Dynamic-threshold Level Set Method

We developed a novel method, called “dynamic-thresholding (DT) level set,” for volumetric segmentation of an organ, such as a kidney. The DT level set provides advantages of thresholding and region-based methods and of deformable models. The level set approach represents surfaces as interfaces, and it uses the framework of partial differential equations (PDEs) to compute surface motion (Osher, et al., 1988). A scalar function, Φ0(x, t), defines an embedding of a surface and is updated in time by a speed function F, where x∈Rⁿ⁺¹ and t represents time. The set of points on the surface, S, is mapped by Φ such that:

S={x|Φ(x)=k}, (2)

where k is an arbitrary scalar value (often zero, called the zero-level set). More detailed descriptions of the level set method can be found in Sethian, 1996 and Osher, 2002.

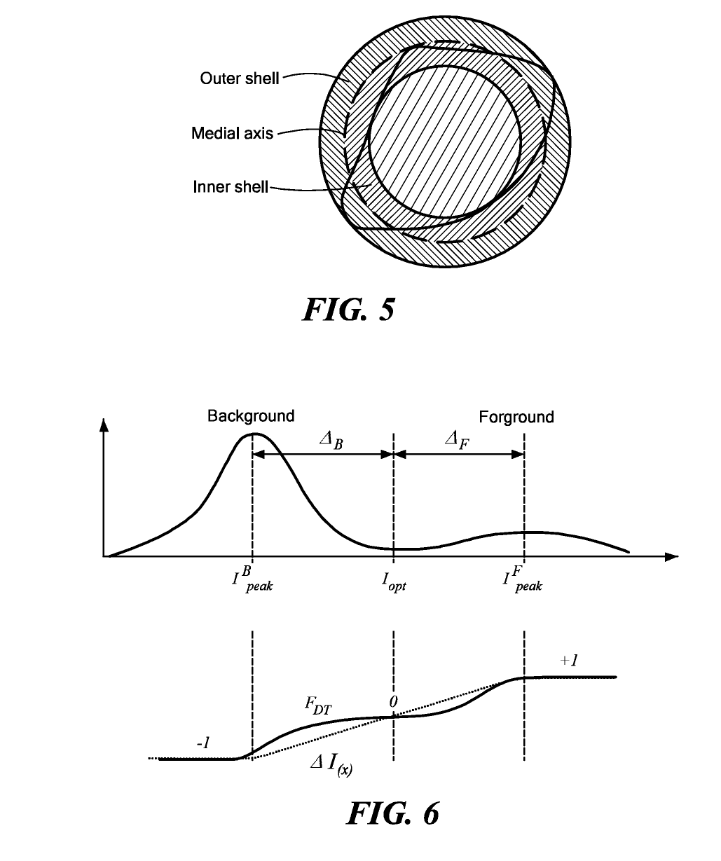

In the DT level set method, we designed a mobile shell structure, which we call a “propagating shell,” and which is a thick region encompassing the level set front. The shell has three components: an inner shell, an outer shell, and a medial axis that separates the inner and outer shells, as illustrated in FIG. 5. The medial axis is located at the level set front, and its motion is controlled by a speed function, called a dynamic-thresholding speed function F_{DT}. When the speed function is positive, the front moves outward (expands); when the speed function is negative, the front moves inward (shrinks).

Ideally, if the shell contains the true boundary of the object, it satisfies the following two conditions: (1) the histogram of the shell includes only the two regions, i.e., the foreground (tumor) and the background regions, and (2) the ratio of these two regions, C_{R}, is approximately one. If the second condition does not hold, the threshold value that indicates the valley between the two regions will be moved to increase the size of the smaller region. This makes it possible to build a propagating shell that is dynamically driven by a speed function by using the threshold value. The propagating shell is pushed or pulled toward the boundary of the object by its speed function; when C_{R} approaches one, the threshold becomes stable, and the shell reaches the convergence position where the inner half shell is located inside the tumor, whereas the outer half is located in the background.

We employed a level set method (Sethian, 1996) for evolving the propagating shell to find the boundary of a liver tumor. The flexibility of the topologic change in the level set method provides substantial advantages over a conventional region-growing or a balloon method; however, a level set driven by a conventional edge speed function may not identify the fuzzy boundary of a liver tumor. We thus integrated the propagating shell into a level set by use of a sparse field (Whitaker, 1998) method as an efficient implementation tool. The thickness of the shell is preset during initialization. The histogram of the shell and the threshold are dynamically updated during the evolution of the propagating shell.

Our level set model (Sean, et al., 2002) is combined with the DT speed function. The DT speed function, F_{DT} in equation (3), is balanced with other smoothness constraints, a mean curvature smoothing term and a numerical stability term for PDEs. Thus, the evolution function of DT level set is:

$$\frac{\partial φ}{\partial t} = {F}_{DT} ( x ) \vert ∇ φ \vert + {C}_{Curvature} ∇ \cdot ( \frac{∇ φ}{\vert ∇ φ \vert} ) \vert ∇ φ \vert + {C}_{SM} {∇}^{2} φ , \qquad ( 3 )$$

where C_{Curvature} and C_{SM} are two control parameters smoothing the segmentation results. In this study, C_{Curvature} and C_{SM} were empirically set to 0.5 and 0.2, respectively.

### Threshold Shift

Construction, operation and use of the propagating shell will be described in the context of determining the volume of a kidney; however, the disclosed methods and apparatus may be used to identify boundaries between any pairs of objects or objects and backgrounds in image data.

Assume that a kidney's boundary can be attributed to a mixture of the renal parenchyma (foreground) and pararenal tissue (background), because of the partial volume effect. The boundary of a kidney lies on the points at which the percentage of the foreground is equal to that of the background, i.e., a 50-50 point, in terms of the probability density functions (PDFs) of both foreground and background. This threshold value at the 50-50 point is called the “theoretical threshold value” and is denoted by T_{theory} herein.

In practice, the PDF is affected by many imaging factors, and it is difficult to obtain the individual PDF of each material in images. Instead, we can calculate a histogram, which is a composition of PDFs weighted by the volume of each material in the images. The optimal threshold, Tₒₚₜ, in a histogram is obtained by minimizing of the overall probability, E(T), of erroneously classifying background voxels to foreground, and foreground voxels to background, by threshold T.E(T) can be minimized by equation (4):

P_{ƒ}·P₇₁ (Tₒₚₜ)=P_{b}·P_{b}(Tₒₚₜ) (4)

where P_{ƒ}and P_{b} are the a priori probabilities of each material, which satisfy P_{ƒ}+P_{b}=1. P_{ƒ}and P_{b} correspond to the percentages of the volume of each material in the images. P_{ƒ}and P_{b} are the PDF functions of the foreground and background.

Suppose that the PDF can be modeled by a normal distribution function with mean value μᵢ and standard deviation σᵢ, and the CT value of the foreground is higher than that of the background, i.e., μ_{ƒ}>μ_{b}. After taking logarithms of equation (4) and simplifying, we can derive the following relationship between Tₒₚₜ and T_{theory}:

Tₒₚₜ|_{Ftc<1}>Tₒₚₜ|_{FtB=1}(T_{theory)}>Tₒₚₜ|_{FtB>1}, (5)

where FtB=V_{ƒ}|V_{b}, which is the volumetric ratio of the foreground material to the background material in the histogram. In other words, the optimal threshold that separates two materials shifts toward the small region in a histogram, relative to the theoretic threshold value. The threshold shift, T_{opt-T}_{theory}, is negative when v_{ƒ}>V_{b}, whereas it is positive when v_{ƒ<v}_{b}. Only when FtB=1(v_{ƒ}=v_{b}), i.e., when the histogram is balanced, is Tₒₚₜ equal to T_{theory}.

Dynamic-Thresholding Speed Function

The propagating shell is designed based on the relationship between Tₒₚₜ and T_{theory} in equation (5). The shell is driven by a DT speed function that is based on the difference between the optimal threshold and the CT value at point x, ΔI(x), as follows:

F_{DT}(x;Iₒₚₜ)=sign(ΔI(x))·|ΔI(x)|ⁿ, (6)

where sign(x) is a sign function (also known as an indicator function), which is 1 if x is positive and −1 if x is negative. The value of n may be based on the smoothness required. Typical values are 2 and 3, although other values, including non-integer values, may be used. ΔI(x) is defined by:

$$Δ I ( x ) = \{ \begin{matrix}- 1 & if I ( x ) \leq {I}_{opt} - {Δ}_{B} \\ ( I ( x ) - {I}_{opt} ) / {Δ}_{B} & if I ( x ) \leq {I}_{opt} \\ ( I ( x ) - {I}_{opt} ) / {Δ}_{F} & if I ( x ) \leq {I}_{opt} + {Δ}_{F} \\ 1 & if I ( x ) > {I}_{opt} + {Δ}_{F}\end{matrix} , \qquad ( 7 )$$

where Δ_{B} and Δ_{F} are the distances between the peak of the background in the histogram and the optimal threshold Iₒₚₜ, and the peak of foreground in the histogram and the optimal threshold Iₒₚₜ, respectively, as shown in FIG. 6. The histogram is calculated from the intersection region between the ROI and the shell.

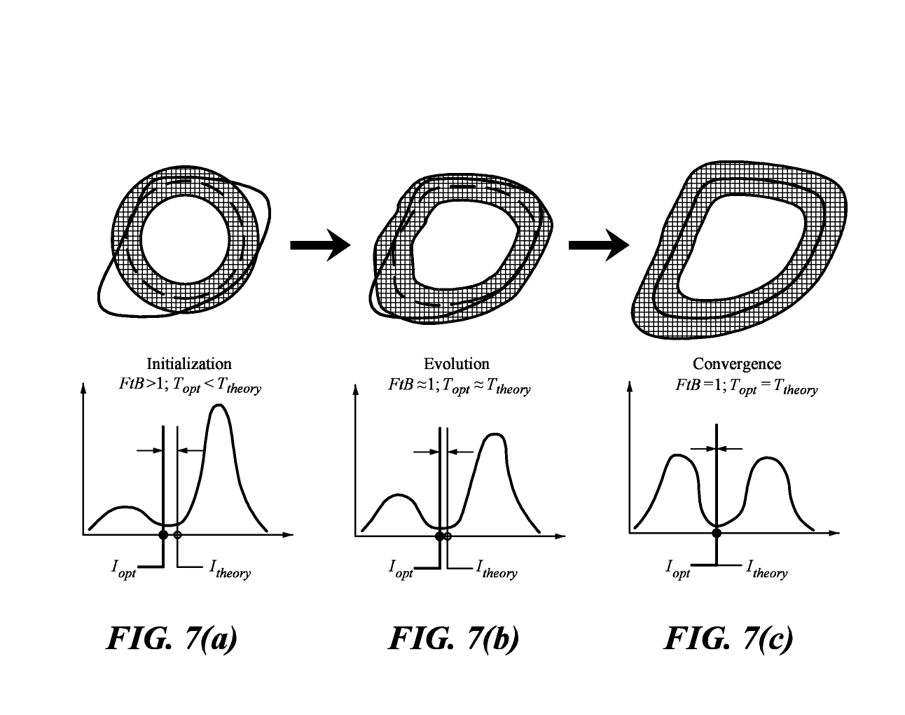

FIG. 7 illustrates three stages of propagation of a shell: (a) initialization, (b) evolution and (c) convergence. When a seed region is initialized within a kidney, FtB is larger than one, i.e., more foreground materials than background materials is included in the propagating shell, as illustrated in FIG. 7(a), and Tₒₚₜ in the initial propagating shell is lower than T_{theory}. This means that the points within the kidney have positive image speeds. As a result, the shell is driven outward, i.e., it expands, and the front of the level set is pushed toward the boundary of the kidney, as illustrated in FIG. 7(b). Thus, more background voxels enter the propagating shell, i.e., FtB approaches one, and Tₒₚₜ comes close to T_{theory}. When FtB becomes equal to one, the optimal threshold becomes equal to the theoretical threshold, i.e., the histogram of the shell is balanced and the shell is settled in a convergence position, where the inner half shell is located in the kidney parenchyma, and the outer half is located in the pararenal space, as illustrated in FIG. 7(c).

### Results

Eight Yorkshire breed anesthetized pigs (weight range 45-50 kg) were scanned on a 64-slice multi-detector CT scanner (Sensation 64, Siemens) after injection of an iodinated (300 mgI/ml) contrast agent through an IV cannula. The kidneys of the pigs were then surgically resected and scanned by CT in the same manner. Both in-vivo and ex-vivo CT images were subjected to our computerized volumetry using DT level set method. The resulting volumes of the kidneys were compared with in-vivo and ex-vivo reference standards. The former was established by manual contouring of the kidneys on the CT images by an experienced radiologist, and the latter was established as the water displacement volume of the resected kidney.

The comparisons of the in-vivo and ex-vivo measurements by our volumetric scheme with the associated reference standards yielded a mean difference of 1.73±1.24% and 3.38±2.51%, respectively. The correlation coefficients were 0.981 and 0.973 for in-vivo and ex-vivo comparisons, respectively. The mean difference between in-vivo and ex-vivo reference standards was 5.79±4.26%, and the correlation coefficient between the two standards was 0.760.

Our computerized volumetry using the DT level set method can provide accurate in-vivo and ex-vivo measurements of kidney volume, despite a large difference between the two reference standards. This technique can be employed in human subjects for the determination of renal volume for pre-operative surgical planning and assessment of oncology treatment.

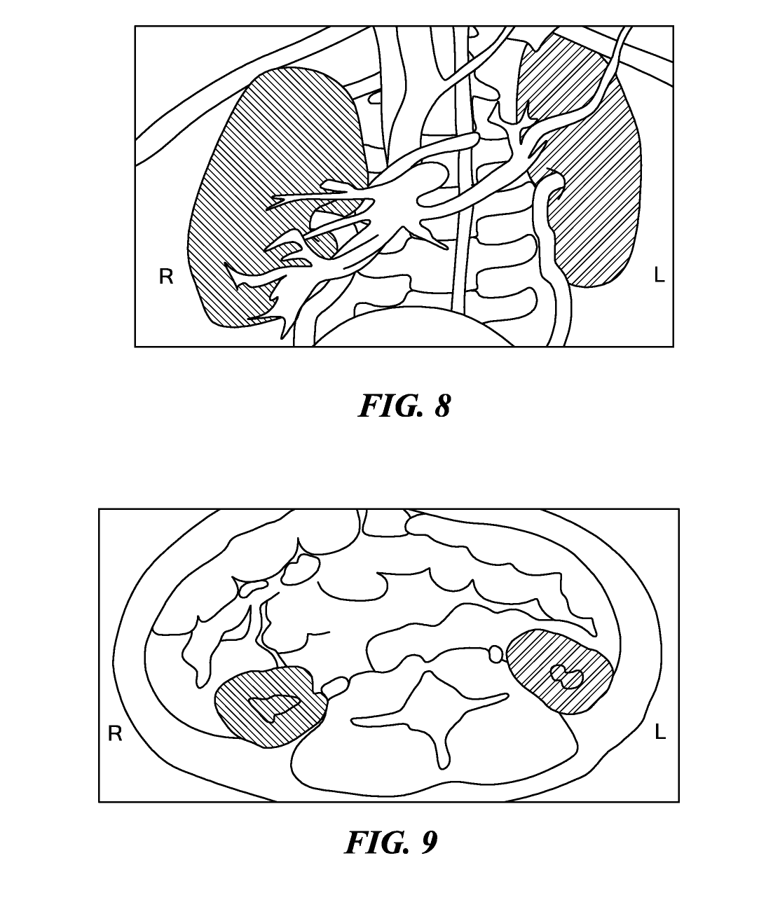

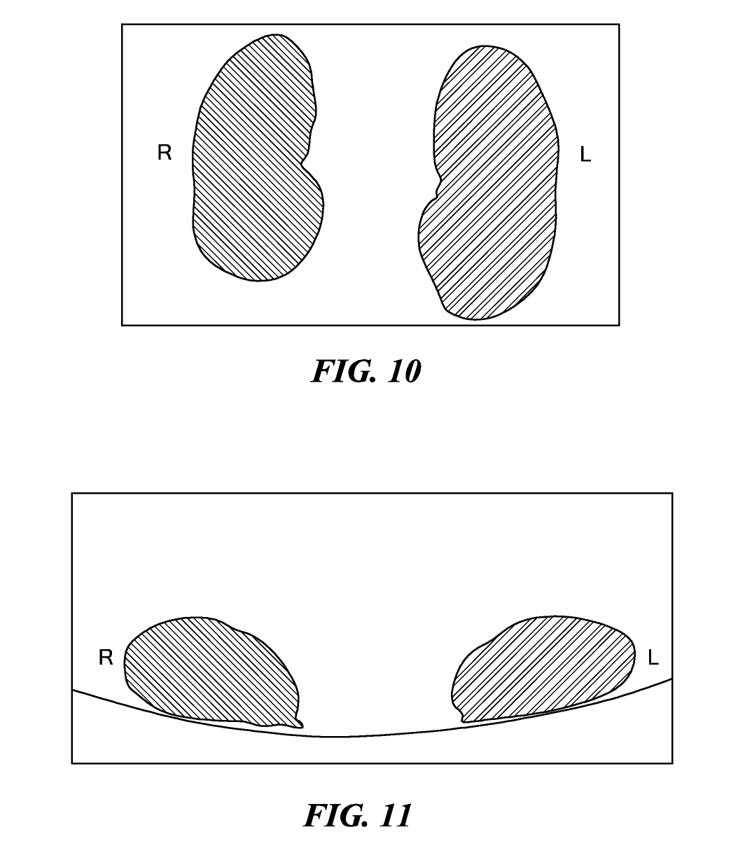

Both in-vivo and ex-vivo CT images were subjected to our volumetry scheme using the DT level set method. The seed regions were interactively determined in the left and right kidneys, respectively. FIGS. 8 and 9 illustrate an example of a pair of segmented left and right kidneys in an in-vivo CT scan. The boundary thresholds from the propagating shell were 136HU and 1145HU for the right (cyan) and left (green) kidney, respectively. FIG. 8 is a 3D image of the segmented left and right kidneys. FIG. 9 is a 2D axial slice of the resulting CT image. The renal vessels within the kidney donut were counted in the kidney volume. In this example, the enhanced renal parenchyma demonstrated average CT values of 282 HU and 278 HU for the right and the left kidneys, respectively, whereas the tissue in the pararenal space (0-50 HU) was not enhanced. The boundary threshold values obtained by the DT level set method were 136 HU and 114 HU, respectively. In FIGS. 10 and 11, we show the segmented left and right kidneys in the same pig in an ex-vivo CT scan. FIG. 10 is a 3D image of the segmented left and right kidney. FIG. 11 is a 2D axial slice of the resulting CT image. In ex-vivo CT images, the average CT values for the right and left renal parenchyma were 127 HU and 135 HU, respectively. Because the resected kidneys were directly exposed in air during the CT scan, the boundary threshold values were reduced compared to the values in the in-vivo CT images, to −230 HU and −210 HU, respectively.

### In-vivo and Ex-vivo Comparison

The resulting volumes of the kidneys from in-vivo and ex-vivo CT images by the DT level set method were compared with the in-vivo and ex-vivo reference standards, respectively: the former was established by manual contouring of the kidneys on the in-vivo CT images by an experienced radiologist, and the latter was established by the volume obtained from water displacement.

The difference between the volumetry measurement and its associated reference standard for each individual kidney is defined as the percentage of the reference:

$$Diff ( {V}_{R} , {V}_{X} ) = \frac{\vert {V}_{X} - {V}_{R} \vert}{{V}_{R}} \cdot 100 \% , \qquad ( 8 )$$

where V_{R} is the volume of the reference standard, and V_{X} is the measured experimental volume. Six groups of comparison were performed, including the comparison between in-vivo computerized volumetry (CV) and in-vivo reference standard (RS), the comparison between ex-vivo CV and ex-vivo RS, the comparison between in-vivo RS and ex-vivo RS, the comparison between ex-vivo RS and in-vivo CV, the comparison between ex-vivo RS and ex-vivo manual volumetry (MV), and the comparison between ex-vivo MV and ex-vivo CV. We calculated the difference of the volume for each individual kidney in each comparison group. Statistical results of comparison among in-vivo reference standard (RS), ex-vivo RS, in-vivo computerized volumetry (CV), ex-vivo CV, and ex-vivo manual volumetry (MV) are shown in Table 1.

TABLE 1

| | Mean | Standard | Median | |
|---|---|---|---|---|
| | Difference | Deviation | Difference | Correlation |
| Diff(V_{R}, V_{X}) | (%) | (%) | (%) | Coefficient |
| (in-vivo RS, | 1.73 | 1.24 | 1.45 | 0.981 |
| in-vivo CV) | | | | |
| (ex-vivo RS, | 3.36 | 2.54 | 2.75 | 0.972 |
| ex-vivo CV) | | | | |
| (in-vivo RS, | 5.79 | 4.26 | 4.91 | 0.760 |
| ex-vivo RS) | | | | |
| (ex-vivo RS, | 4.71 | 4.14 | 3.06 | 0.835 |
| in-vivo CV) | | | | |
| (ex-vivo RS, | 14.77 | 2.20 | 15.19 | 0.913 |
| ex-vivo MV) | | | | |
| (ex-vivo MV, | 13.42 | 3.32 | 13.29 | 0.934 |
| ex-vivo CV) | | | | |

The comparisons between in-vivo and ex-vivo computerized volumetry and the reference standards yielded differences of 1.73±1.24% and 3.36±2.54%, respectively. The correlation coefficients were 0.981 and 0.972 for in-vivo and ex-vivo comparisons, respectively. We demonstrated that our computerized volumetry using the DT level set method yielded no significant difference from the reference standard.

The difference between the in-vivo and ex-vivo reference standards was 5.79±4.26%, and the correlation coefficient between the two standards was 0.760. In addition, the comparison between the ex-vivo reference standard and in-vivo computerized volumetry yielded a difference of 4.71±4.14%, with a correlation coefficient of 0.835.

The ex-vivo volumetry by manual contouring was compared with the ex-vivo reference standard and ex-vivo computerized volumetry. The results presented large differences of 14.77±2.20% and 13.42±3.32%, respectively. We observed that the manual contouring consistently underestimated the volumes. The mean volume difference between ex-vivo manual volumetry and the ex-vivo reference standard was −22.14 cc, whereas it was −17.24 cc between ex-vivo manual volumetry and ex-vivo computerized volumetry. One of the major sources of these differences was that radiologists were not familiar with the contouring of organs exposed to air. The CT value at the ex-vivo kidney boundary was lower than that of the in-vivo boundary. In addition, the traditional window level set for manual organ contouring tends to obscure the boundary of the kidney because of the partial volume effect.

### Volumetric Segmentation Scheme for Liver Tumors

We developed a three-stage volumetrics scheme for liver tumors based on the dynamic-threshold level set method: (1) segmentation of the liver, (2) detection of tumors in the segmented liver, and (3) segmentation and measurement of the volume of the detected liver tumors.

In the first stage, a part of the liver that is close to the right lung is detected based on anatomic knowledge, and a shell is initialized to the detected region. At this stage, the shell includes both the liver and the background region, that is, un-enhanced soft-tissue structures. Then the shell is evolved by use of the dynamic-threshold speed function for delineation of the boundary of the liver.

In the second stage, seed regions in the potential liver tumors in the segmented liver are identified based on CT values and a minimum-volume criterion. The algorithm works as follows: first, empirical minimum and maximum threshold CT values of a lesion are set based on the threshold value obtained in the first step. The segmented liver is filtered by a median filter, i.e., if and only if the medium value at the neighborhood of a voxel is between the above two threshold values, the voxel is added to a “lesion candidate volume.” The lesion candidate volume is eroded once, and the mass of each connected region is computed. Those candidate volumes that had more than a pre-defined value are identified as the seed regions.

In the last stage, new propagating shells are initialized to the above seed regions, and they are evolved to delineate the boundary of the individual tumors. During the evolution of the level set, some seed regions are merged together, whereas others are collapsed and merged into the background. The resulting tumors are used for calculation of the total volume of the tumors.

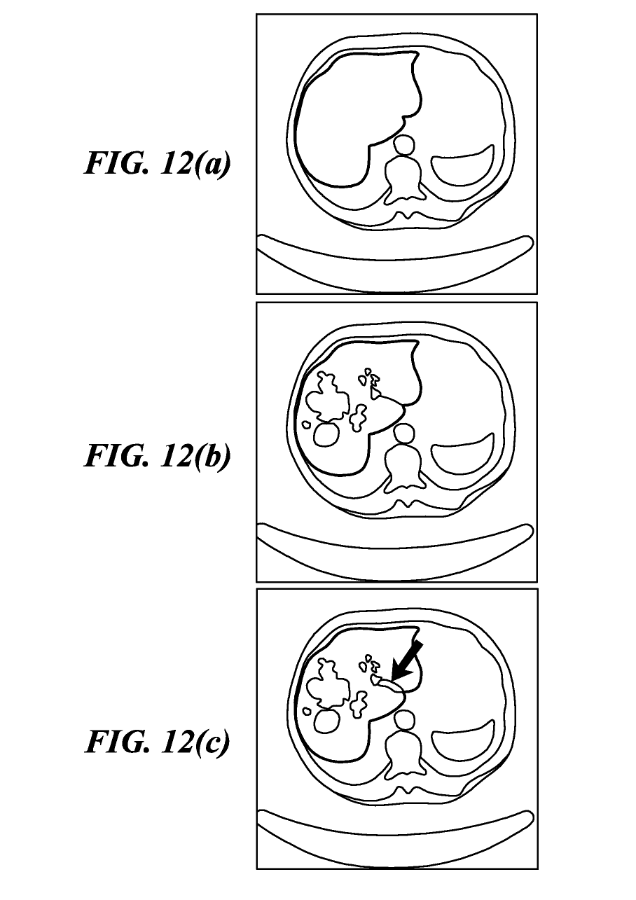

FIG. 12 shows the application of the above three-stage volumetric scheme to one of our clinical cases. FIG. 12(a) shows the boundary of the liver as obtained from stage one, above, by a white closed contour. In the second stage, seed regions for lesion candidates were identified within this extracted liver region as shown by white dots in FIG. 12(b). In this example, a total of 24 seed regions were detected. These 24 seed regions were subjected to the segmentation process in the third stage, and ten lesions were finally segmented as shown by the white contours within the liver (FIG. 1(c)). By comparing FIGS. 1(b) and 1(c, we observe the merging and collapsing of the seed regions in the segmentation process. In addition, we observe that the boundary of the tumor is fuzzy and is not always the same as the maximum gradient location of the regions. One may also notice that there is a false-positive detection at the boundary between the left and right lobes (white arrow). All detected tumors are subjected to confirmation by users before computation of the total volume of the tumors.

Seven hepatic CT cases were used for evaluation of the accuracy of our volumetrics scheme. These cases were obtained by multi-detector CT scanners with the following parameter settings: 2.5-5-mm collimation, 1.25-2.5-mm reconstruction interval, 175-mA tube current, and 140-kVp tube voltage. All cases were acquired with use of an intra-venous contrast agent (ISOVULE; GE Healthcare, Milwaukee, Wis.).

Fifteen biopsy-confirmed metastases and hemangiomas were identified in the portal venous phase images, and they were subjected to our volumetrics scheme. These 15 tumors were also segmented manually, and the resulting volumes were compared with those obtained by the computerized scheme. The tumor volumes ranged from 0.8 cc to 69.9 cc, and the average difference between the manual and computerized volume measurements was 4.0%. The t-test showed that the two volume measurements were not statistically significantly different (p=0.963). The high correlation coefficient (r=0.9998) showed that the two volume measurements were highly correlated, indicating that the computer-measured volumes were consistent with those of manual measurement.

### Using Propagating Shell to Detect the Optimal Histogram and Combine the Method into Level Set Segmentation Algorithm

Our dynamic thresholding level set method combines two optimization processes, i.e. the level set segmentation and the optimal threshold calculation in a local histogram, into one process with a structure called “propagating shell.” Propagating shell is a mobile shell structure with a certain thickness encompassing the object boundary. In one aspect, propagating shell is a window to calculate a local histogram, from which the threshold is determined. In another aspect, propagating shell serves as a deformable interface for level set to approach object boundary. The threshold and the edge profile calculated from the local histogram of a propagating shell form the speed function in level set. When the propagating shell is placed symmetrically along an object boundary, the local histogram is a combination of two PDFs with equal weights, we called a balanced histogram. The optimal threshold estimated from this balanced histogram has the minimal difference from the theoretic threshold calculated from PDF. This difference is called threshold shift in this paper. Because optimal threshold tends to shift to the value of a small region in a histogram, this shift can drive the propagating shell to object boundary by pushing or pulling the propagating shell. In other words, the segmentation process is an optimizing process to find the balanced histogram with minimal threshold shift. When the ratio of object to background approaches 1:1, the histogram is balanced, the threshold becomes stable, and the propagating shell reaches the convergence location, i.e. the object boundary.

Suppose that there are two materials in a local region, foreground material (object) and background material. A fuzzy boundary is a mixture of two materials, due to the partial volume effect (PVE). Thus, the probability that a voxel has value I, Pr(I), is given by equation (9).

Pr(I)=P_{ƒ}P_{ƒ}(I)+p_{b}P_{b}(I)

P_{ƒ}+p_{b}=1; p_{ƒ}≧0; p_{b}≧0 (9)

where Pᵢ(I) is the probability that material i has value I, i.e. the probability density function (PDF) ; and pᵢ is the percentage of material i in voxel.

### Boundary is at 50/50 Point of the Probability Function

Assuming that the PDF of Pᵢ(I) is known, then the percentage of each material within a voxel of intensity I can be estimated by equation (10), in terms of Bayesian estimation.

$${p}_{i} ( I ) = \frac{{P}_{i} ( I )}{{P}_{f} ( I ) + {P}_{b} ( I )} \qquad ( 10 )$$

The boundary of an object can be determined by a decider D in equation (11)11).

$$D = \{ \begin{matrix}{p}_{f} > {p}_{b} : foreground voxel \\ {p}_{f} = {p}_{b} : boudary voxel \\ {p}_{f} < {p}_{b} : background voxel\end{matrix} \qquad ( 11 )$$

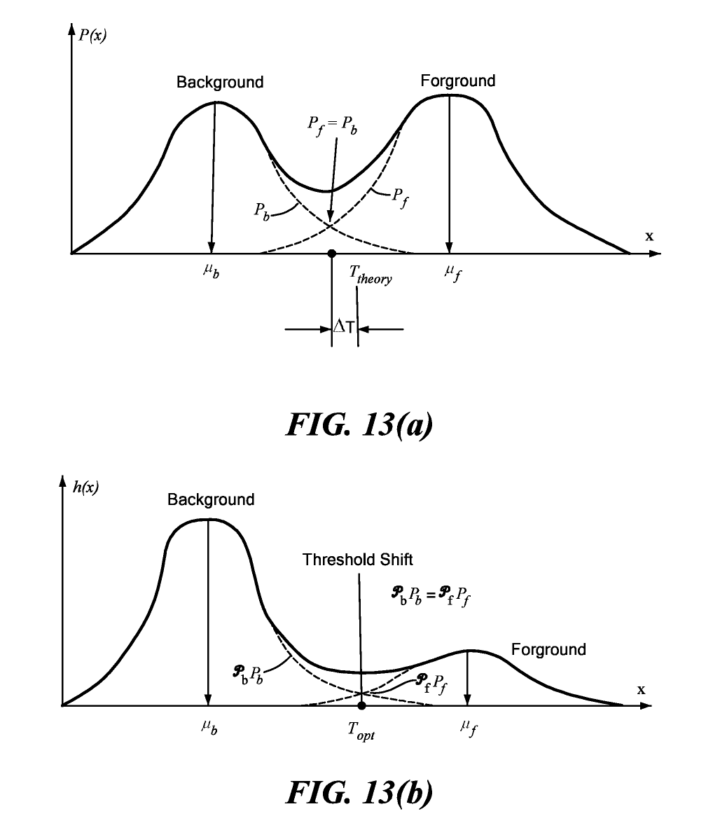

Boundary voxels are labeled where P_{ƒ}=p_{b}=0.5, i.e. 50-50 points. That is to say, the boundary is at the point for which P_{ƒ}(I)=P_{b}(I). If P_{ƒ}and P_{b} are monotonic functions in the boundary region, threshold T by equation (12) can be solved, as shown in FIG. 13(a). FIG. 13(a) illustrates a probability density function of two materials P_{ƒ}and P_{b}. The ideal threshold is defined at a point where P_{ƒ}equals P_{b}. As FIG. 13(b) illustrates, in a bimodal histogram, the optimal threshold is calculated by minimizing the probability of erroneously classifying, i.e., Tₒₚₜ is at a point where P_{b}P_{b}=P_{ƒ}P_{ƒ}.

T={I|P_{ƒ}(I)=P_{b}(I)} (12)

This threshold is called a theoretic threshold, which is calculated directly from PDF. In practices, PDF is affected by many factors, and it may vary in different images. Instead of PDF, the threshold may be estimated from a histogram.

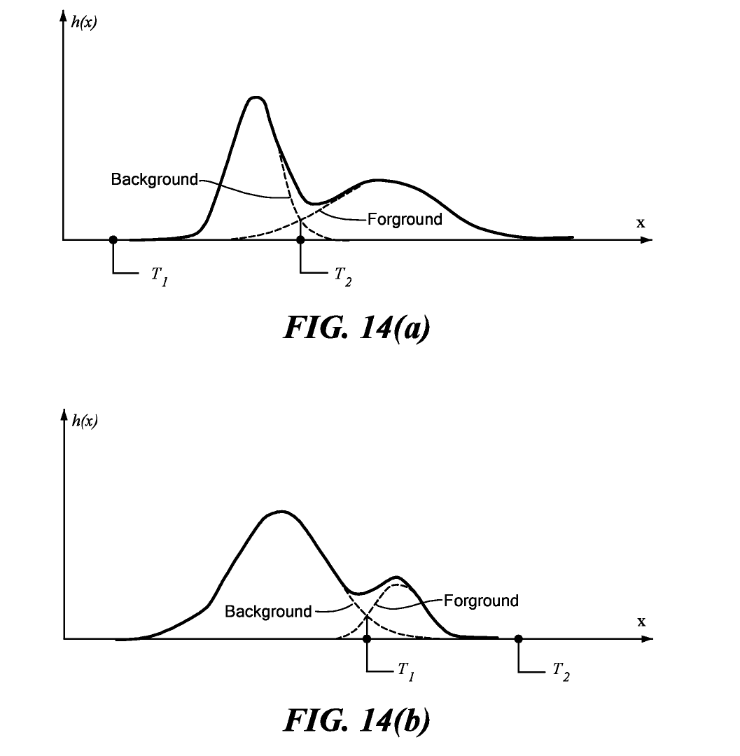

FIG. 14 illustrates a case where 6_{ƒ}!=6_{b} and B²−4AC>0. There are two threshold roots in Equation (14), T1 and T2(T1<T2) In FIG. 14(a), 6_{ƒ}>6_{b}(A>0), T2 is selected as the applicable threshold. In FIG. 14(a), 6_{ƒ}<6_{b}(A<0), T₁ is selected as the applicable threshold.

### Optimal Threshold in Histogram

Assuming that the distribution of both materials, object (foreground) and background, can be modeled by a normal distribution function with mean value μᵢ and standard deviation σᵢ; for ease of discussion, we suppose that foreground corresponds to bright regions whereas background corresponds to dark regions, i.e. μ_{f}>μ_{b}. Thus, the mixture probability density function or the histogram distribution of an image is:

$$\begin{matrix}h ( x ) = {P}_{f} \cdot {P}_{f} + {P}_{b} \cdot {P}_{b} \\ = P \cdot \frac{1.0}{\sqrt{2 π} {σ}_{f}} exp ( - \frac{{( x - {μ}_{f} )}^{2}}{2 {σ}_{f}^{2}} ) + {P}_{b} \cdot \\ \frac{1.0}{\sqrt{2 π} {σ}_{b}} exp ( - \frac{{( x - {μ}_{b} )}^{2}}{2 {σ}_{b}^{2}} )\end{matrix} \qquad ( 13 )$$

where Pf and Pb are the a priori probabilities of two materials, which satisfies P_{f}+P_{b}=1.

### Optimal Threshold is Minimizing the Overall Probability of Error

Optimal threshold is calculated by minimizing the overall probability E(T) of erroneously classifying background voxel to object and object voxels to background by threshold Tin the histogram (Gonzalez and Woods, 1992). E(T) is minimized by equation:

P_{ƒ}·P_{ƒ}(T)=P_{b}·P_{b}(T) (14)

where Tis the optimal threshold, which is illustrated in FIG. 13(b).

### Optimal Threshold is not the Theoretic Threshold

Thus, the optimal threshold given by (14) is determined by not only their inherit imaging features (PDF: Pᵢ(I)), but also their a priori probabilities in images. The a priori probabilities P_{f} and P_{b} are proportional to the occupied regions of each material in images. Thus, when P_{f} equals P_{b}, the histogram is balanced, and the optimal threshold estimated from the balanced histogram approximates the theoretic threshold in equation (12), which is calculated from PDF. The difference between optimal threshold and theoretic threshold is called threshold shift, which is illustrated in FIG. 13.

### Threshold Shift

After taking logarithms and simplifying, equation (14)14) turns into the quadratic equation given by equation (15)15) (Gonzalez and Woods, 1992),

$$\begin{matrix}{AT}^{2} + BT + C = 0 & ( 15 ) \\ where & \\ \begin{matrix}A = {σ}_{f}^{2} - {σ}_{b}^{2} \\ B = 2 ( {μ}_{f} {σ}_{b}^{2} - {μ}_{b} {σ}_{f}^{2} ) \\ C = {μ}_{b}^{2} {σ}_{f}^{2} - {μ}_{f}^{2} {σ}_{b}^{2} + 2 {σ}_{b}^{2} {σ}_{f}^{2} ln ( \frac{{σ}_{b} {P}_{f}}{{σ}_{f} {P}_{b}} )\end{matrix} & ( 16 )\end{matrix}$$

The threshold values are given by:

$$T = \frac{- B \pm \sqrt{{B}^{2} - 4 A C}}{2 A} \qquad ( 17 )$$

### Case of Same Variance

Suppose that both materials have the same variance of distribution, i.e. σ_{b=σ}_{f}=σ. The optimal threshold is at the Tₒₚₜ (Gonzalez and Woods, 1992), see equation (18)18).

$${T}_{opt} = - \frac{C}{B} = {T}_{theory} + Δ T = \frac{{μ}_{f} + {μ}_{b}}{2} + \frac{{σ}^{2} \cdot ln ( {P}_{b} / {P}_{f} )}{( {μ}_{f} - {μ}_{b} )} \qquad ( 18 )$$

### This shows us that the optimal threshold (minimum error point) is not at the ideal thresholding position given by μ_{b}+μ_{ƒ})/2. There is a shift AT determined by the logarithm of the ratio of P_{b} and P_{f}.

### The Shift is Towards the Material of Small Region

The a priori probabilities of the histogram, P_{ƒ}and P_{b}, are proportional to the regions of each material in images. Thus, the threshold shift ΔT is determined by equation (19)19).

$$Δ T = \frac{{σ}^{2} \cdot ln ( {V}_{b} / {V}_{f} )}{( {μ}_{f} - {μ}_{b} )} = - \frac{{σ}^{2} \cdot ln ( FtB )}{( {μ}_{f} - {μ}_{b} )} \qquad ( 19 )$$

where V_{b} and V_{f} are the volumes of each material in images; and FtB is the ratio of foreground to background (V_{f}: V_{b}).

If FtB<1(V_{ƒ}<V_{b}), ΔT>0 when μ_{ƒ>μ}_{b}. Thus, ΔT is shifted towards foreground. In another word, the estimation of the optimal threshold is shifted towards the material of which the percentage in images is small. The shift is minimized when V_{ƒ}=V_{b}.

### Cases of Different Variance

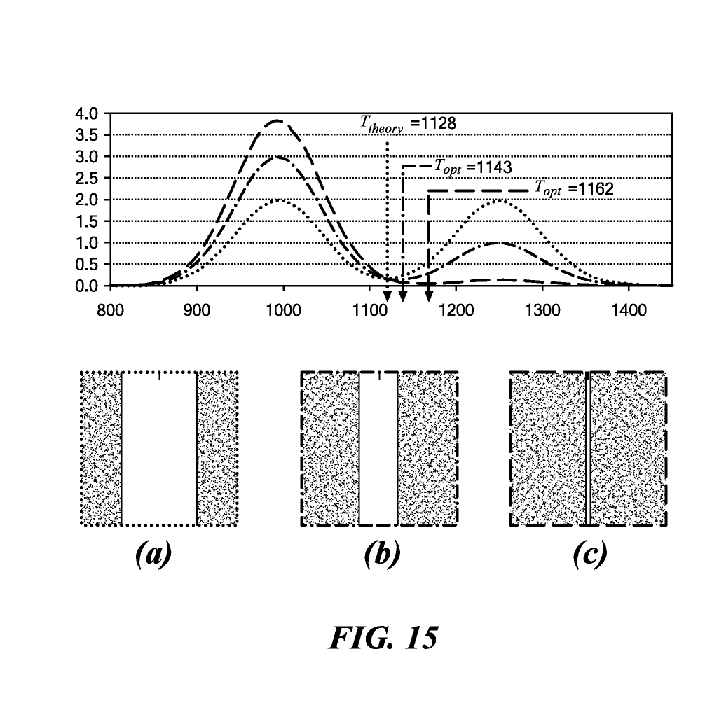

In practices, it is usually the case that σ_{ƒ}≠σ_{b} and B²−4AC>0. Thus, equation (17)17) has two real roots, T₁ and T₂ (T₁<T₂). Since we assume μ_{ƒ>μ}_{b}, if A>0 (σ_{ƒ>σ}_{b}), T₂ is the optimal threshold; otherwise A<0 (σ_{ƒ}<σ_{b}), T₁ is the optimal threshold. FIG. 15 illustrates both situations. FIG. 15 illustrates histograms of two materials with different foreground-to-background ratios. In FIG. 15(a), V_{f}:V_{b}=1:1; in FIG. 15(b), V_{f}:V_{b}=1:3; and in FIG. 15(c), V_{f}:V_{b}=1:15. The theoretic threshold is 1,128 HU. The threshold shift ΔT is 0, 15 and 34, respectively.

In this case, the theoretic threshold is given when FtB (P_{ƒ}:P_{b})=1 in equation (16)16). After analyzing the relationship between FtB and the roots of quadratic equation (17), we observe:

Tₒₚₜ|_{FtB<1}>Tₒₚₜ|_{FtB=1}(T_{theory)}>Tₒₚₜ|FtB>1 (20)

In other words, we reach the same conclusion that we get in the case of same variance, i.e., that the optimal threshold shifts towards the small region in images corresponding to the theoretic threshold.

In the cases that B²−4AC=0 and B²−4AC<0, there are no applicable threshold from equation (17)17). Both situations are very rare in practices.

It is an optimization process to determine the threshold T and to estimate the histogram parameters Pᵢ, μᵢ, and σᵢ of each material. We used minimum error method (Kittler and Illingworth, 1986; Glasbey, 1993) to find the best fit of two Gaussian distributions in a histogram. Thus, the optimal threshold is estimated.

### Example of Threshold Shift

One example of threshold shift is demonstrated in FIG. 15 by three histograms computed from three data; which include a slab with intensity of 256 HU on a background intensity of 0 HU. The variance (σ²) of the Gaussian distribution of white noises is 2,560. The theoretical threshold is (0+256)/2=128 HU. The ratios of foreground (slab) to background (FtB) (V_{f}:V_{b}) are 1:1, 1:3, and 1:15 respectively. We observe when the FtB ratio is 1:1, the optimal threshold of the histogram is at the theoretic threshold 128 HU. When the FtB ratio is 1:3, Tₒₚₜ is at 140 HU. When the FtB ratio increases to 1:15; then Tₒₚₜ moves to about 162 HU.

### Propagating Shell

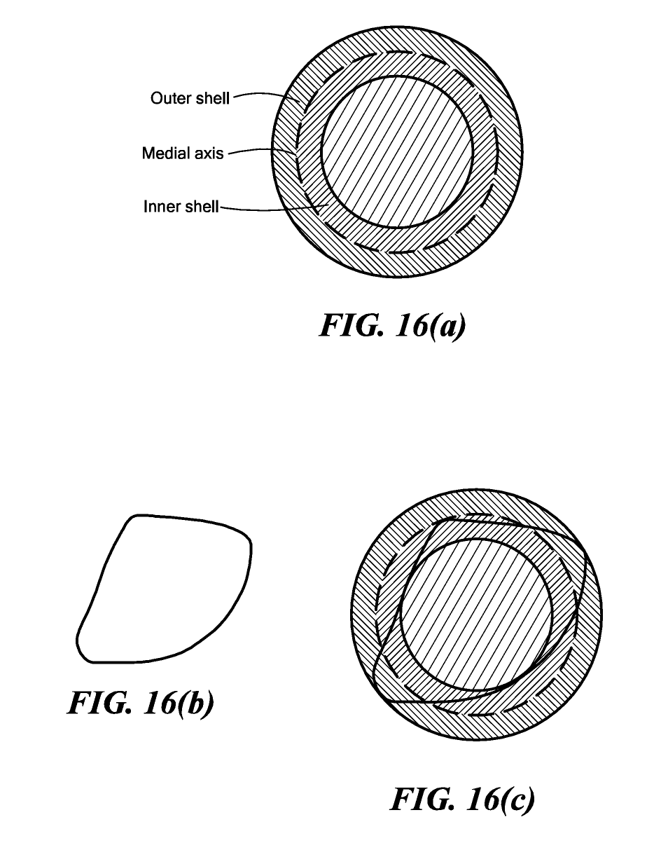

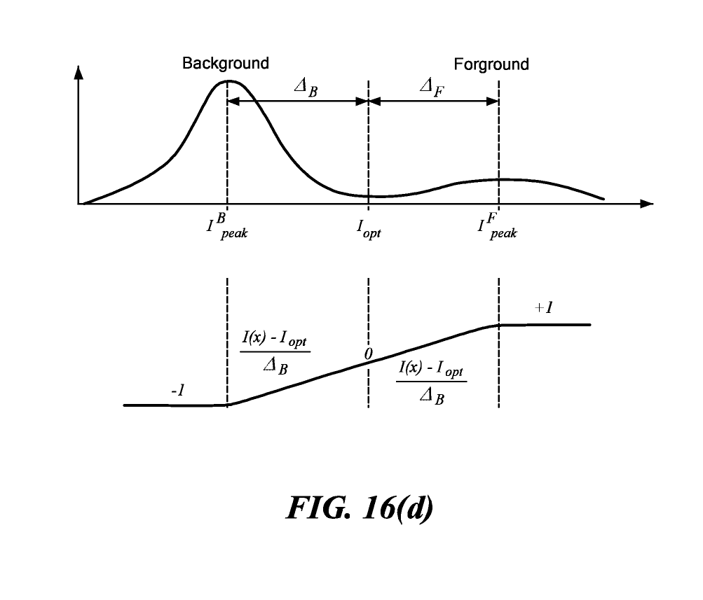

A shell is defined as a thick region encompassing the boundary of an object. The shell consists of three components: an inner shell, an outer shell, and the medial axis that separates the inner and outer shell, as illustrated in FIG. 16(a). Both inner shell and outer shell have the same thickness, which is the radius of the shell. The medial axis of a propagating shell is a mobile surface, and its motion is controlled by a signed speed function.

Histogram in Shell

When the shell overlaps on an object, the intersection region between the shell and the region of interest (ROI) includes two materials, the object and its background, as illustrated in FIG. 16(c). Depends on the location of the shell, or the medial axis, the percentage of each material in the shell varies. Assuming there are two materials in the shell, the local histogram of the shell is bimodal. The optimal threshold calculated from this local histogram is shifted towards the small region in the shell according to equations (18)18) and (20)20).

### Speed Function in Propagating Shell

This speed function modulates the movement of the shell. We use a dynamic threshold speed function, in which the speed is calculated in terms of the difference between the optimal threshold and the gray value at point x, i.e. ΔI(x). The speed function is given by equation 21).

F_{DT}(x;I_{valley})=sign(ΔI(x))·|ΔI(X)|ⁿ (21)

where sign(x) is a sign function (also known as indicator function), 1 if x is positive and −1 if x is negative; ΔI(x) is given in equation (22); n is often set 2 or 3.

$$Δ I ( x ) = \{ \begin{matrix}- 1 & if I ( x ) \leq {I}_{valley} - {Δ}_{B} \\ ( I ( x ) - {I}_{opt} ) / {Δ}_{B} & if I ( x ) \leq {I}_{valley} \\ ( I ( x ) - {I}_{opt} ) / {Δ}_{F} & if I ( x ) \leq {I}_{valley} + {Δ}_{F} \\ 1 & if I ( x ) > {I}_{valley} + {Δ}_{F}\end{matrix} , \qquad ( 22 )$$

where Δ_{B} and Δ_{F} are the difference between the peak of background to threshold Iₒₚₜ and the peak of foreground to threshold Iₒₚₜ respectively, which are illustrated in FIG. 16(d).

### Propagation Process

If the object is brighter than background, i.e. μ_{F}>μ_{B}, and the medial axis is initialized within an object, and the radius of the shell is wide enough to reach the background, the histogram is bimodal, and FtB in the shell is larger than 1. (This assumption is not necessary at the beginning. If the whole shell is located within the object, we can just simply expand it until it reaches the background.) The object shares a bigger portion in the histogram of the shell than its background. Then, the threshold is shift toward the background.

### Propagation Driven by the Threshold Shift

The threshold shift is the driving force of the propagation shell. At the initialization stage, the optimal threshold Tₒₚₜ, is lower than its real value, see FIG. 7(a); the medial axis is pushed outwards (expansion) due to positive ΔI(x) in speed function (21). During evolution, the point at the medial axis is driven outwards/inwards depend on its speed is positive/negative. Propagating drives more background voxels into the shell and more object voxels out the shell, as illustrated in FIG. 7(b). The points on medial axis stop moving when: (1) the speed at a point is zero and (2) the signs of the speeds on both sides of the point are opposite. Finally, ΔT will approach zero when the histogram is balanced, i.e. FtB approaches to one.

### Difference Between Optimal Threshold and Optimal Histogram

The relationship between the threshold shift and the speed function on the medial axis triggers the motion of shell. The mobility and deformability of propagating shell optimizes the window for a local histogram and thus the optimal threshold approximates to the theoretic threshold of these two materials.

### Combining Propagating Shell with Level Set Implementation

Mathematically level set approach is explained as a n-dimensional surface embedded in a Rⁿ⁺¹ space. A scalar function, Φ(x, t) defines an embedding of a surface, where x∈R^{n⇄1} and t is time. The level set function 0 is updated in time by equation (23).

Φ(x,t+Δt)=Φ(x,t)+ΔtF|∇Φ| (23)

where F is a signed, scalar speed function that defines the speed in the direction normal to Φ at any point x. The detail description of level set can be found in (Sethian, 1996) and (Osher and Fedkiw, 2002).

To combine the propagating shell with level set model, the dynamic thresholding speed function, F_{DT} in equation (21)21), needs to be balanced with other smoothness constraints, mean curvature and image smoothing factors (Sean et al., 2002). Thus the evolution function is:

$$\frac{\partial φ}{\partial t} = {F}_{DT} ( x ) \vert ∇ φ \vert + {C}_{curvature} ∇ \cdot ( \frac{∇ φ}{∇ t} ) \vert ∇ φ \vert + {C}_{SM} {∇}^{2} φ \qquad ( 24 )$$

where C_{Curvature} and C_{SM} are two control parameters smoothing the segmentation results. The settings of these two parameters are based on the irregularity of the surface boundary and the quality of the image.

### Discrete Layer Model

The propagation shell is defined in 3-dimensional (3D) Euclidean space, R³. Let layer Lᵢ denote the set of grid points of which each individual element X is i blocks away (city block distance) from the medial axis:

Lᵢ={X=(x,y,z)∈R³|i−½≦Dist(X)≦i+½} (25)

where Dist(X) is the function calculating the minimum distance (city block distance) of point X to the medial axis of shell. Value i is called the status of a grid point.

### Layer Structure and Propagating Shell

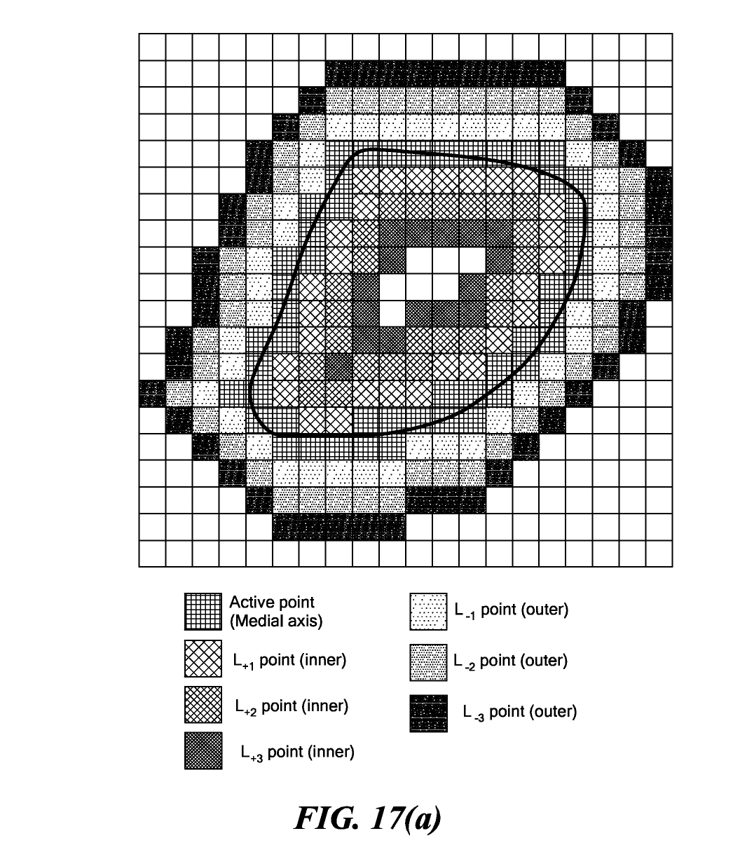

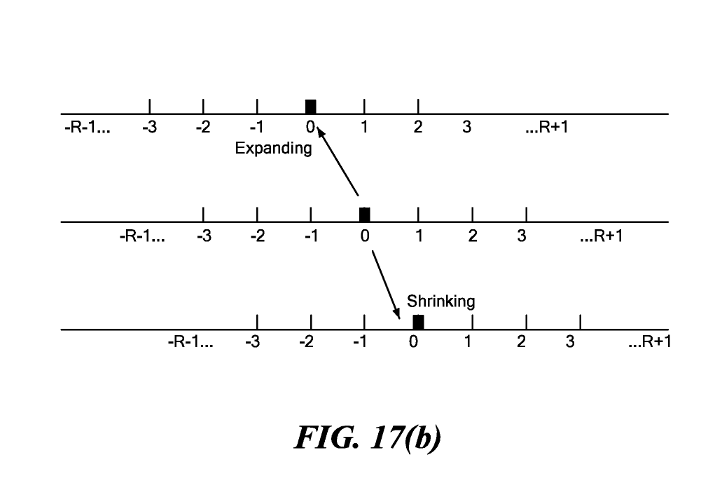

L₀ is a set of points adjacent to the surface of medial axis, which lies in the interval [−½,+½] from the medial axis. L₀ is called the active set; the grid point in the active set is called an active point. The inner shell is composed of the sets of layers L₊₁, L₊₂, . . . , L_{+R} and the outer shell is composed by layers L₋₁, L₋₂ , . . . , L_{-R}, where R indicates the radius of shell. FIG. 17(a) illustrates a discrete model, three-layer propagation shell, i.e. a shell with a radius of three. Other grid points that are not covered by the shell are labeled status either—R−1 (outside the medial axis) or R+1 (inside the medial axis). We adopt the sparse-field method (Whitaker, 1998) to implement the propagating shell.

### Algorithm

The evolution of propagating shell is performed on the active set and then updates the neighborhood around the active set using a fast distance transform (city block distance). The active point has a value of Φ in the range of [− 8 1/2, +½]. An active point is removed from the active set when the value of 0 at that point no longer lies in the interval [−½, +½]. The sparse-field method (Whitaker, 1998) updates the active set and its relevant points in a very efficient way that allows the active points to enter and leave with those changes in status of only affecting grid points, as shown in FIG. 17(b). FIG. 17(b) illustrates the relationship between medial axis movement and status updating.

The algorithm is outlined below:

Initialize the shell and its histogram; compute the optimal threshold from the histogram. Then, set up the speed function F_{DT}.

Run the following iteration until no voxels moving in/out of the shell
For each active point, X₀=(i,j,k) calculate the net change of Φ(X₀), according to the shell propagation equation (24). Add the net change to X₀ and decide if the new value Φⁿ⁺¹(X₀) falls outside the [−½, ½] interval.
If Φⁿ⁺¹(X₀)∈[−½, ½], X₀ stay in the active set, i.e L₀
If Φⁿ⁺¹(X₀)<−½, i.e. the grid point is driven inwards, the status of X₀ is changed from 0 to −1. So, X₀ is removed from the active set and added to the status updating list S (0→−1). Its neighbor grid points with status 1 become active points, i.e. added to the active set and the status updating list S(1→0).
If Φⁿ⁺¹(X₀)>½, i.e. the grid point is driven outwards, the status of X₀ is changed from 0 to 1. So, X₀ is removed from the active set and added to the status updating list S(0→+1). Its neighbor grid points with status −1 become active points, i.e. added to the active set and the status updating list S(−1→0).
Update the status of gird point in the shell by the updating sequences below (Whitaker, 1998):
   S(0→±1): the status updating sequence is
   {S₀(0→±1), S₁(±1→±2), S₂(±2→±3), . . . , S_{R}(±R→±R±1) }
   S(±1→0): the status updating sequence is
   {S₀(±1→0), S₁(±2→±1), S₂(±3→±2), . . . , S_{R}(±R±1→±R) }
Update the histogram, the optimal threshold, and the speed function.

The active set and the status changing can be implemented efficiently using link-list data structures. The histogram of the shell is updated when grid points move in or out of the shell. When a point is moved from outside (±R±1) into the shell, i.e. by the status updating list S_{R}(±R±1→±R), a bin corresponding to its intensity in the histogram increases by one. On the contrary, when a point is moved out of the shell, i.e. by the status updating list S_{R}(±R→±R1), the corresponding bin decreases by one. Thus, the histogram is updated in a very efficient way.

The radius (thickness) of a shell is the main parameter to construct the shell. If it is too small, the initial shell does not contain enough background. In this case, the process may not converge. If the radius is too big, the shell may contain many materials, other than the object and the background. This changes the histogram and may affect the calculation of the optimal threshold. Ideally, the shell contains two materials, the object and background, and the shell covers the transition interval of the boundary, i.e. the fuzzy region between object and background. In our experiments, we used a radius of seven. We tested radii from five to 19 to demonstrate the stability of the shell in terms of radius. Other radii may, of course, be used. The results of our tests are listed in Table 2.

TABLE 2

| | Radius of shell | | | | | | | |
|---|---|---|---|---|---|---|---|---|
| | 5 | 7 | 9 | 11 | 13 | 15 | 17 | 19 |
| Resulting | 306 | 310 | 314 | 314 | 316 | 318 | 320 | 322 |
| threshold | | | | | | | | |
| Tumor volume | 27.028 | 27.815 | 27.801 | 27.633 | 27.253 | 26.945 | 26.599 | 26.218 |
| (cc) | | | | | | | | |

We observed that the resulting tumor volume does not significantly change when the radius size is between seven and 15. But larger radii mean more computation time. Another phenomenon we observed in this table is the resulting threshold shifted towards the tumor when the radius becomes large. This is caused by the self-intersection of the inner shell, which reduced the region of tumors in the histogram. We observed that with a radius of five, the threshold was 306, but the tumor volume was reduced. This situation, i.e., a small tumor volume at a lower threshold situation, was caused by a large Δ_{F}, i.e. the high peak position of tumor object in the local histogram, which was at 615. In other cases, the peak of the tumor in the histogram was at 385. This was caused by the under-sampling of the tumor objects in the histogram. In other words, the radius should be large enough to encompass both materials to calculate a stable bimodal histogram.

The propagating shell and calculations of the speed function and other calculations described above may be performed by a computer executing instructions stored in a suitable memory. Such a system may be embedded in a larger system, such a CT scanner. Optionally or alternatively, the described system may be implemented as a stand-alone program that is executed by a workstation or as part of a larger software and/or hardware system.

While the invention is described through exemplary embodiments, it will be understood by those of ordinary skill in the art that modifications to, and variations of, the illustrated embodiments may be made without departing from the inventive concepts disclosed herein. Moreover, while the preferred embodiments are described in connection with CT data and various illustrative organs, one skilled in the art will recognize that the system may be used with other diagnostic techniques (such as magnetic resonance imaging (MRI) and ultrasound), other organs, non-organs and the inanimate objects. Accordingly, the invention should not be viewed as limited, except by the scope and spirit of the appended claims.

A propagating shell and speed function system has been described as including a processor controlled by instructions stored in a memory. The memory may be random access memory (RAM), read-only memory (ROM), flash memory or any other memory, or combination thereof, suitable for storing control software or other instructions and data. Some of the functions performed by the propagating shell and speed function system have been described with reference to flowcharts and/or block diagrams. Those skilled in the art should readily appreciate that functions, operations, decisions, etc. of all or a portion of each block, or a combination of blocks, of the flowcharts or block diagrams may be implemented as computer program instructions, software, hardware, firmware or combinations thereof. Those skilled in the art should also readily appreciate that instructions or programs defining the functions of the present invention may be delivered to a processor in many forms, including, but not limited to, information permanently stored on non-writable storage media (e.g. read-only memory devices within a computer, such as ROM, or devices readable by a computer I/O attachment, such as CD-ROM or DVD disks), information alterably stored on writable storage media (e.g. floppy disks, removable flash memory and hard drives) or information conveyed to a computer through communication media, including wired or wireless computer networks. In addition, while the invention may be embodied in software, the functions necessary to implement the invention may optionally or alternatively be embodied in part or in whole using firmware and/or hardware components, such as combinatorial logic, Application Specific Integrated Circuits (ASICs), Field-Programmable Gate Arrays (FPGAs) or other hardware or some combination of hardware, software and/or firmware components.

While the invention is described through the above-described exemplary embodiments, it will be understood by those of ordinary skill in the art that modifications to, and variations of, the illustrated embodiments may be made without departing from the inventive concepts disclosed herein. Moreover, while the embodiments are described in connection with various illustrative data structures, one skilled in the art will recognize that the system may be embodied using a variety of data structures. Furthermore, disclosed aspects, or portions of these aspects, may be combined in ways not listed above. Accordingly, the invention should not be viewed as limited.

What is claimed is:

1. A method for segmenting an object that is represented by image data, the method comprising:
defining a region that encompasses a boundary between at least a portion of the object and at least part of a second object; and
evolving the region by use of a dynamic-thresholding speed function.

2. A method as defined in claim 1, wherein the second object is a background.

3. A method as defined in claim 1, wherein defining the region comprises initializing a level set front to at least a portion of the object.

4. A method as defined in claim 1, wherein evolving the region comprises an iterative process.

5. A method as defined in claim 1, wherein the dynamic-thresholding speed function comprises an image-feature-based speed term.

6. A method as defined in claim 5, wherein the dynamic-thresholding speed function further comprises a curvature-based smoothness constraint term.

7. A method as defined in claim 5, wherein the image-feature-based speed term represents a difference between a computed tomography value at a point in the region and a threshold value calculated dynamically from a histogram of the region.
